(19) United States
(12) Patent Application Publication
(10) Pub. No.: US 2025/0356476 A1
(43) Pub. Date: Nov. 20, 2025

(54) INCOMPATABILITY DETECTION DEVICE AND INCOMPATABILITY DETECTION METHOD

(71) Applicant: Hitachi High-Tech Corporation, Tokyo (JP)

(72) Inventors: Munetoshi UNUMA, Tokyo (JP); Yasutaka TOYODA, Tokyo (JP); Shinichi SHINODA, Tokyo (JP); Tomoyuki OKUDA, Tokyo (JP); Takahiro MOTOYOSHI, Tokyo (JP); Sota KOMATSU, Tokyo (JP); Masayoshi ISHIKAWA, Tokyo (JP)

(73) Assignee: Hitachi High-Tech Corporation, Tokyo (JP)

(21) Appl. No.: 18/872,877

(22) PCT Filed: Jun. 21, 2022
(86) PCT No.: PCT/JP2022/024750

§ 371 Date: Dec. 9, 2024

(51) Int. Cl. G06T 7/00

(52) U.S. Cl. CPC G06T 7/0008; G06T 2207/30148

(57) ABSTRACT

An incompatibility detection unit comprises: an image conversion unit that converts an input low-quality image into a corresponding high-quality image using a learning model; an incompatibility detection unit that detects whether or not the input low-quality image is incompatible with the learning model; an incompatibility reporting unit that reports detected incompatibility; and a storage unit that stores, as a model-compatible region, the distribution of evaluation values of high-quality correct images used in the training stage of the learning model, in association with the learning model. The incompatibility detection unit determines that the learning model is incompatible when an evaluation value of the input low-quality image is not within the model-compatible region.

### TECHNICAL FIELD

The present invention relates to an incompatibility detection device and an incompatibility detection method.

### BACKGROUND ART

A system for converting a low-quality image to a high-quality image using machine learning has been described in PTL 1. In the system described in PTL 1, a learning model for machine learning is generated using the low-quality image and the high-quality image. Then, in the system described in PTL 1, a low-quality input image is converted into a high-quality output image by machine learning using the learning model.

### CITATION LIST

### Patent Literature

PTL 1: WO2021/095256

### SUMMARY OF INVENTION

### Technical Problem

In the system described in PTL 1, the learning model is prepared in advance for each purpose of improving image quality. For example, for the purpose of noise removal, a learning model for noise removal corresponding to a magnitude of noise is prepared. In addition, a learning model corresponding to a magnitude of aberration is prepared for aberration improvement.

A user selects a learning model to be used based on the purpose of improving the image quality and a state of the image quality of the low-quality image (noise and aberration situation). In the system described in PTL 1, the user visually selects a learning model for noise removal. Therefore, it is easy to determine whether the selected learning model is effective for the noise removal.

Image conversion processing using the learning model has a property of converting an input image so as to approach an image of training material data used during training of the learning model. Therefore, when the input image having noise is input to the learning model trained based on the training material data without noise, an effect is expected that an output image whose noise is removed from the input image is obtained so as to approach the training material data.

On the other hand, unexpected secondary image conversion processing different from the purpose of the learning model may also occur. For example, when a shape and a position of an object A photographed in the training material data are greatly different from a shape and a position of an object B photographed in the input image, the object B of the output image is deformed so as to approach the object A. As a result of such unexpected deformation, the meaning of the image is changed, and for example, a use situation of the image after conversion such as visually inspecting whether an object is a normal product or a defective product is also affected. This affection is because the learning model used for the image conversion processing is incompatible for the input image.

Therefore, a main object of the invention is to detect incompatibility of a learning model used for image conversion processing.

### Solution to Problem

In order to solve the above problem, an incompatibility detection device according of the invention has the following features.

The invention includes: an image conversion unit configured to convert an input image-before-conversion into an image-after-conversion using a learning model; an incompatibility detection unit configured to detect whether the image-before-conversion is incompatible with the learning model; an incompatibility reporting unit configured to report detected incompatibility; and a storage unit configured to store, as a model-compatible region, a distribution of evaluation values of training images used in a training stage of the learning model, in association with the learning model. The incompatibility detection unit determines that the learning model is incompatible when an evaluation value of the image-before-conversion is not within the model-compatible region.

Other means will be described later.

### Advantageous Effects of Invention

According to the invention, it is possible to detect incompatibility of a learning model used for image conversion processing.

### BRIEF DESCRIPTION OF DRAWINGS

FIG. 1 is an external view showing that a circuit pattern of a semiconductor formed in two upper and lower layers according to an embodiment is imaged.

FIG. 2 is a diagram of a circuit pattern formed on a semiconductor wafer of FIG. 1 according to the embodiment.

FIG. 3 is a diagram showing a deviation amount obtained from the semiconductor wafer of FIG. 2 according to the embodiment.

FIG. 4 is a configuration diagram of an incompatibility detection unit used in an image conversion system that converts a low-quality image into a high-quality image according to the embodiment.

FIG. 5 is a configuration diagram of the incompatibility detection unit according to the embodiment.

FIG. 6 is a configuration diagram of a model training unit according to the embodiment.

FIG. 7 is a flowchart showing a flow of processing performed by the incompatibility detection unit according to the embodiment.

FIG. 8 is a diagram showing a section definition method of a model-compatible region according to the embodiment. Two types of the definition method are shown below.

FIG. 9 is a diagram showing an example of a setting method of the model-compatible region according to the embodiment.

FIG. 10 is a table showing a first example of a region expression method according to the embodiment.

FIG. 11 is a table showing a second example of the region expression method according to the embodiment.

FIG. 12 is a table showing a third example of the region expression method in which the table of FIG. 11 according to the embodiment is expanded to a two-dimensional element.

FIG. 13 is a table showing a modification in which a directory name storing a training pair image is stored in a cell value of the table of FIG. 12 according to the embodiment.

FIG. 14 is a data structure showing a fourth example of the region expression method in which the table of FIG. 11 according to the embodiment is expanded to a three-dimensional element.

FIG. 15 is a configuration diagram of an incompatibility countermeasure unit according to the embodiment.

FIG. 16 is a flowchart showing specific processing of incompatibility countermeasure processing according to the embodiment.

FIG. 17 is a configuration diagram showing a modification of the incompatibility countermeasure unit of FIG. 15 according to the embodiment.

FIG. 18 is a hardware configuration diagram of the image conversion system according to the embodiment.

FIG. 19 is a diagram showing a state in which a numerical value in a table is changed by retraining for the table of the model-compatible region which is the same expression method as in FIG. 11 according to the embodiment.

FIG. 20 is a graph showing a situation of occurrence of an error in a low-quality image before processing (before improving image quality) performed by an image conversion unit according to the embodiment.

FIG. 21 is a graph showing a situation of occurrence of an error in a corresponding high-quality image after processing (after improving image quality) performed by the image conversion unit according to the embodiment.

FIG. 22 is a diagram showing a state of a measurement error when an image is converted using a learning model in which the deviation amount of the training pair image according to the embodiment is defined as a model-compatible region [−5, 5).

FIG. 23 is a graph showing a situation of occurrence of an error based on a first training result according to the embodiment.

FIG. 24 is a graph showing a situation of occurrence of an error based on a second training result according to the embodiment.

### DESCRIPTION OF EMBODIMENTS

An image conversion system for converting a low-quality image into a high-quality image according to the embodiment will be described with reference to the drawings.

### Embodiment 1

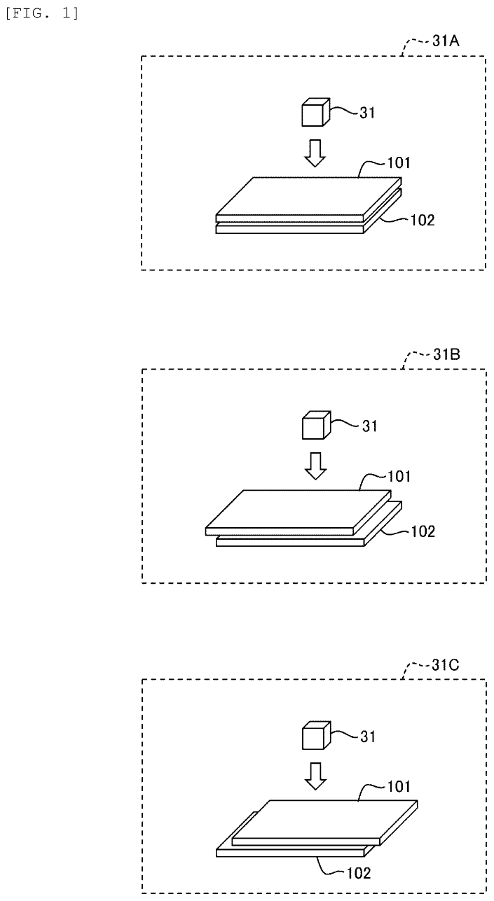

FIG. 1 is an external view showing that a circuit pattern of a semiconductor formed in two upper and lower layers is imaged.

In an imaging environment 31A, an upper layer circuit 101 and a lower layer circuit 102 are formed in a multilayer structure (here, two upper and lower layers) by performing etching, impurity addition, and thin film formation, and an integrated semiconductor wafer is an imaging target. An electron microscope 31 captures an image by irradiating the semiconductor wafer from above (from a side close to the upper layer circuit 101) with an electron beam (an arrow in the drawing). The semiconductor wafer in the imaging environment 31A is a normal product in which no positional deviation has occurred between the upper layer circuit 101 and the lower layer circuit 102.

In an imaging environment 31B, the semiconductor wafer in which the upper layer circuit 101 and the lower layer circuit 102 are formed and integrated with each other is an imaging target. The upper layer circuit 101 in the imaging environment 31B is formed to be slightly positional deviated to the left side with respect to the lower layer circuit 102. Accordingly, in the imaging environment 31B, it is necessary to detect that the semiconductor wafer is a defective product based on the captured image of the electron microscope 31.

In an imaging environment 31C, the upper layer circuit 101 is also formed to be slightly positional deviated to the right side with respect to the lower layer circuit 102. Accordingly, even in the imaging environment 31C, it is necessary to detect that the semiconductor wafer is a defective product based on the captured image of the electron microscope 31.

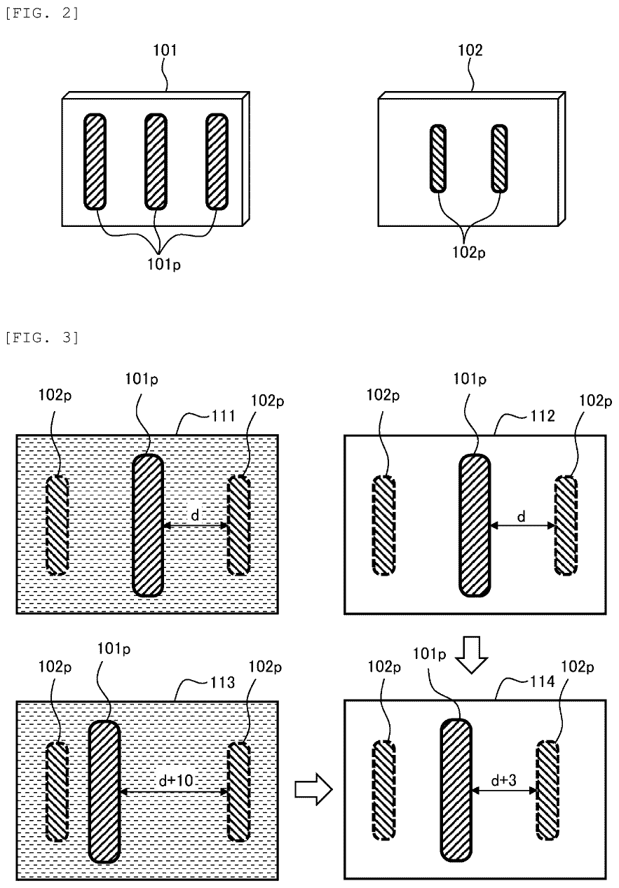

FIG. 2 is a diagram of a circuit pattern formed on the semiconductor wafer of FIG. 1.

Circuit patterns are formed in the upper layer circuit 101 and the lower layer circuit 102 by using a mask for each layer. In order to make the description easy to understand, a circuit pattern 101p of the upper layer circuit 101 is slightly longer than a circuit pattern 102p of the lower layer circuit 102 in an upper-lower direction.

Although a large number of circuit patterns are actually formed in one semiconductor wafer, a small number of circuit patterns are shown in FIG. 2 for the purpose of description.

FIG. 3 is a diagram showing a deviation amount obtained from the semiconductor wafer of FIG. 2.

Captured images 111 to 114 show a part of the captured image of the semiconductor wafer in which the upper layer circuit 101 and the lower layer circuit 102 are formed and integrated with each other (FIG. 3 is a rough view, and a part of the circuit pattern after superimposition is extracted and shown in an enlarged manner). As shown in FIG. 1, the electron beam of the electron microscope 31 passes through the upper layer circuit 101 on the front side and the lower layer circuit 102 on the back side. Therefore, both the circuit patterns are photographed on the captured image.

For example, in the captured images 111 to 114, a first circuit pattern (one of the circuit patterns 102p), a second circuit pattern 101p (one of the circuit patterns 101p), and a third circuit pattern 102p (one of the circuit patterns 102p) are imaged in order in a left-right direction.

The captured images 111 and 112 are captured images of a normal product in which no positional deviation has occurred. The first, second, and third circuit patterns are arranged at an equal distance d in the left-right direction. That is, a deviation amount when the distance d is used as a reference is 0.

The captured image 111 is a low-quality image with a low resolution in which white noise (noise), distortion, and the like are included in addition to the circuit pattern (in the drawing, white noise is expressed by hatching).

The captured image 112 is a high-quality image with a high resolution and less noise and distortion. Although the circuit pattern is arranged in the same manner as in the captured image 111, no white noise is imaged.

Here, the training pair image is a pair of images serving as training materials when training a learning model 14. One of the pair is input data to the learning model 14, and the other of the pair is output data to the learning model 14. For example, when a low-quality image such as the captured image 111 is input to the learning model 14 that performs image conversion processing called noise, a high-quality image such as the captured image 112 is output. At this time, a pair of the captured image 111 and the captured image 112 showing the same object is referred to as the training pair image.

Hereinafter, when the trained learning model 14 is operated, the learning model 14 receives the captured image 113 before the image conversion as the input data, and sets the captured image 114 after the image conversion as the output data.

The captured image 113 is a low-quality image obtained by capturing an image of a defective product in which positional deviation occurs. In addition to unnecessary white noise, a distance d+10 between the second and third circuit patterns is larger than the distance d of the captured image 111 (the second circuit pattern is deviated to the left side by a deviation amount=+10).

The captured image 114 is a high-quality image improved in image quality by applying the learning model 14 to the captured image 113. As an effect of improving the image quality, in the captured image 114, unnecessary white noise included in the captured image 113 is clearly removed. However, as a side effect of improving the image quality, a position of the circuit pattern in the captured image 113 is changed such that a positional relationship of the circuit pattern in the captured image 114 approaches that of the circuit pattern in the captured image 112 (the second circuit pattern is deviated to the left side by a deviation amount=+3).

That is, as shown in the training pair image, it is expected that the deviation amount is originally not converted (no error occurs) before and after the image conversion. However, an error of 10−3=7 occurs between the deviation amount=+10 in the captured image 113 and the deviation amount=+3 in the captured image 114. Accordingly, as described below, a result of image determination also causes the following erroneous determination due to an affection of the error.
Originally, based on a large deviation amount (threshold=deviation amount of 5 or more) called “+10” in the captured image 113, it is possible to correctly determine that the imaged semiconductor wafer is a defective product.
However, based on a small deviation amount (threshold=deviation amount less than 5) called “+3” in the captured image 114, the imaged semiconductor wafer is erroneously recognized as a normal product.

As described above, when training is performed using the captured image 112 having a small deviation amount during the generation of the learning model 14, arrangement information of the circuit pattern is also trained in addition to the noise removal of the image. Therefore, when the captured image 113 having a large deviation amount is input, it is considered that processing of approaching arrangement information of the captured image 112 trained during training is performed, and the captured image 114 is output.

Noise removal of an image is image conversion effective for improving measurement accuracy. Such a movement of the circuit pattern is inappropriate image conversion that reduces the measurement accuracy. A learning model that performs such inappropriate image conversion is referred to as “learning model incompatibility”.

The learning model incompatibility cannot be determined by visually checking the captured image 114. The noise removal of the image is normally performed, and it is not possible to determine whether the movement of the circuit pattern is an original movement (occurrence of deviation) or the movement is made due to the learning model incompatibility. Therefore, it is necessary to adopt a mechanism for detecting that the learning model is incompatible and reporting that the learning model is incompatible.

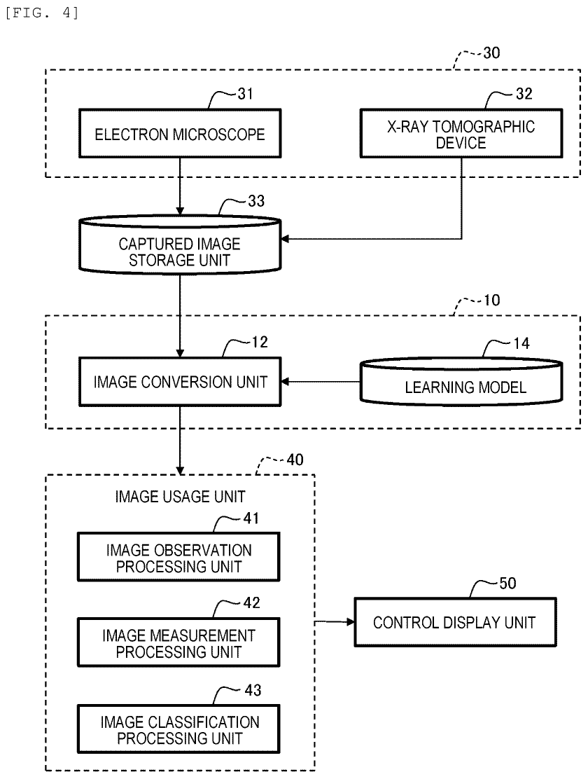

That is, the image quality of the captured image 114 itself is improved by removing white noise, and it is difficult for an inspector to visually recognize an error of the deviation amount included in the captured image 114 (a position change of the circuit pattern). Therefore, an incompatibility detection unit 10 according to the embodiment, which will be described in FIG. 4 and the subsequent drawings, detects the error of the deviation amount as the incompatibility of the learning model 14 and notifies the inspector of the detection result, thereby allowing the inspector to recognize a problem that is not noticed by visually observing a captured image.

FIG. 4 is a configuration diagram of the image conversion system that converts a low-quality image into a high-quality image.

The image conversion system includes the incompatibility detection unit 10, an incompatibility countermeasure unit 20, an imaging device 30, an image usage unit 40, and a control display unit 50.

The incompatibility detection unit 10 detects the incompatibility of the learning model 14, which is used for image conversion processing such as image quality improvement processing, for machine learning. An image conversion unit 12 of the incompatibility detection unit 10 converts a low-quality image 11 into a high-quality image using the learning model 14. The high-quality image after conversion is used for image observation and image measurement. In general, in order to capture a high-quality image, the following imaging conditions are used.
An imaging time is increased.
A plurality of short-time exposure images are captured, and an integrated average thereof is obtained.
Strong illumination light is emitted.

However, there is also the imaging device 30 that cannot perform imaging under such imaging conditions. Examples of the imaging device 30 include the electron microscope 31 and an X-ray tomographic device 32. The electron microscope 31 irradiates an observation object (for example, a semiconductor wafer) with an electron beam, and observes a state of a circuit pattern formed on the wafer.

When the circuit pattern is damaged due to the irradiation of the electron beam, the circuit pattern may be thinned (shrunk). The cause of the shrinkage is long-time exposure (including imaging of the plurality of short-time exposure images) and a high acceleration voltage. Accordingly, the high-quality image cannot be captured at a high frequency.

Even in the X-ray tomographic device 32, the same problem as that of the electron microscope 31 occurs. The X-ray tomographic device 32 irradiates a human body with X-rays to capture an image. It is possible to capture a high-quality image by increasing an irradiation time or increasing an X-ray intensity. However, since this causes an increase in an X-ray exposure amount, it is difficult to capture a high-quality image according to such a method. Accordingly, in order to minimize damage to an object, it is preferable to capture the low-quality image 11.

Accordingly, the low-quality image 11 captured by the imaging device 30 in this manner is stored in a captured image storage unit 33. Then, the image conversion unit 12 converts the low-quality image 11 in the captured image storage unit 33 into a corresponding high-quality image 13 (an image having image quality corresponding to a high-quality image). Although a configuration in which the low-quality image 11 is input to the incompatibility detection unit 10 via the captured image storage unit 33 has been described, the low-quality image 11 may be input directly from the imaging device 30 to the incompatibility detection unit 10.

The corresponding high-quality image 13 output from the incompatibility detection unit 10 is input to the image usage unit 40.

The image usage unit 40 includes an image observation processing unit 41, an image measurement processing unit 42, and an image classification processing unit 43.

The image observation processing unit 41 performs various types of image processing such as enlargement and reduction in order to observe an input image.

The image measurement processing unit 42 measures a size of a shape using the image processing. For example, the image measurement processing unit 42 performs image processing using the converted corresponding high-quality image 13, and extracts edge portions in the circuit pattern 101p of the upper layer circuit 101 and the circuit pattern 102p of the lower layer circuit 102 in FIG. 2, respectively. Then, the image measurement processing unit 42 extracts the distance d between edges shown in FIG. 3.

The image classification processing unit 43 processes classification of an input image to an object. Although not shown, the image usage unit 40 performs image processing in a processing field in which a processing performance is reduced in the low-quality image 11, such as image segmentation processing for classifying image regions.

The control display unit 50 performs various types of control and displays processing results of the image usage unit 40.

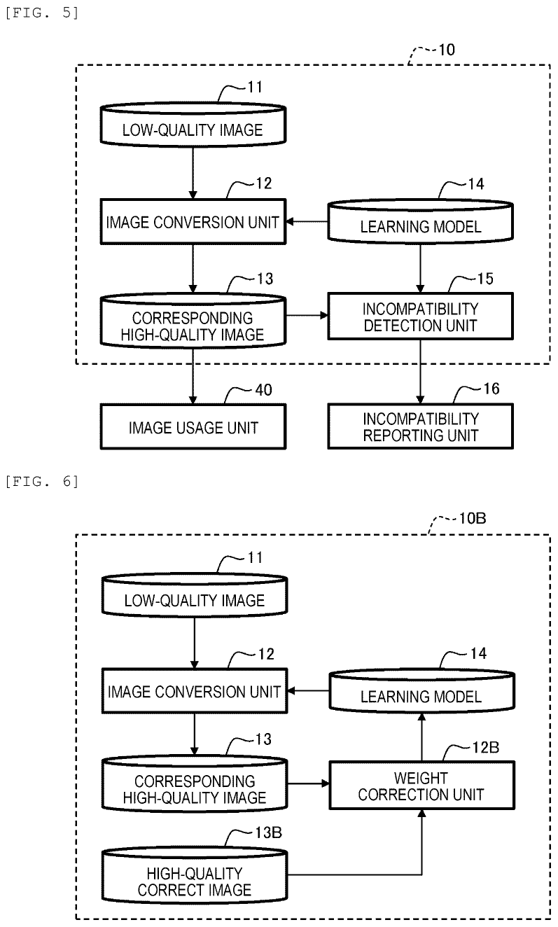

FIG. 5 is a configuration diagram of the incompatibility detection unit 10.

The incompatibility detection unit 10 includes the image conversion unit 12 and an incompatibility detection unit 15. The incompatibility detection unit 10 stores the low-quality image 11 (the captured image 113 in FIG. 3), the corresponding high-quality image 13 (the captured image 114 in FIG. 3), and the learning model 14.

The image conversion unit 12 outputs, by using the learning model 14, the corresponding high-quality image 13 from the low-quality image 11 captured by the input imaging device 30. The learning g model 14 is a machine-learned model such as convolutional neural network (CNN). The CNN is a unit that converts the low-quality image 11 into the corresponding high-quality image 13 using the learning model 14.

The incompatibility detection unit 15 detects whether the input low-quality image 11 to be processed by the image conversion unit 12 and the learning model 14 are incompatible. Information of a model-compatible region indicating an evaluation value (deviation amount and the like) of a training pair image used in training process of the learning model 14 is registered, as information for detecting the incompatibility by the incompatibility detection unit 15, in a storage unit of the incompatibility detection unit 10 in association with each learning model 14. The information of the model-compatible region is expressed, for example, as a section of the deviation amount of the training pair image used at the time of training.

When the evaluation value of the input low-quality image 11 is not within a range of the model-compatible region, the incompatibility detection unit 15 determines that the learning model 14 is incompatible.

An incompatibility reporting unit 16 reports to the inspector, as a detection result of the incompatibility detection unit 15, that the learning model 14 used for the conversion processing on the low-quality image 11 to be processed by the image conversion unit 12 is incompatible in a presentation manner such as screen display or a sound.

FIG. 6 is a configuration diagram of a model training unit 10B.

The model training unit 10B includes the image conversion unit 12 and a weight correction unit 12B. The model training unit 10B stores the low-quality image 11 (the captured image 111 in FIG. 3), the corresponding high-quality image 13 (the captured image 112 in FIG. 3), a high-quality correct image 13B, and the learning model 14.

The high-quality correct image 13B is a high-quality image having a target (correct answer) of image quality improvement for the low-quality image 11. In a case of the semiconductor wafer, the high-quality correct image 13B may be a test wafer. In a case of X-rays, the high-quality correct image 13B may be an X-ray imaging phantom simulating a human body.

The high-quality correct image 13B paired with the low-quality image 11 is a training pair image, and is an image having the same viewing angle at the same position as that of the low-quality image 11.

The imaging condition for the high-quality correct image 13B includes an irradiation amount of the electron beam and X-rays larger than that of the imaging condition for the low-quality image 11. Once the learning model 14 is generated, the high-quality correct image 13B becomes unnecessary at the time of image conversion of the other low-quality image 11.

The weight correction unit 12B corrects a weight of the learning model 14 such that the image quality of the corresponding high-quality image 13 approaches the high-quality correct image 13B. The weight of the learning model 14 is, for example, a weight coefficient of the network of the CNN. Accordingly, the weight of the learning model 14 is not set in an initial state. Accordingly, deviation occurs between the high-quality correct image 13B and the corresponding high-quality image 13 obtained by converting the low-quality image 11 into an image by the image conversion unit 12.

The weight correction unit 12B calculates a correction amount for correcting the weight coefficient of the learning model 14 for correcting the deviation amount, and corrects the learning model 14.

The model training unit 10B stores, in the storage unit, a distribution of an evaluation value of a training image used in the training stage of the learning model 14 as a model-compatible region, in association with the learning model 14.

Weight correction processing performed by the weight correction unit 12B is repeated using a plurality of training pair images, and ends when a weight correction amount decreases. At the end of the weight correction processing, the deviation between the corresponding high-quality image 13 and the high-quality correct image 13B is minimized. By using the learning model 14 at the end of the weight correction processing, the image conversion unit 12 can generate, from the low-quality image 11, the corresponding high-quality image 13 having image quality close to that of the high-quality correct image 13B.

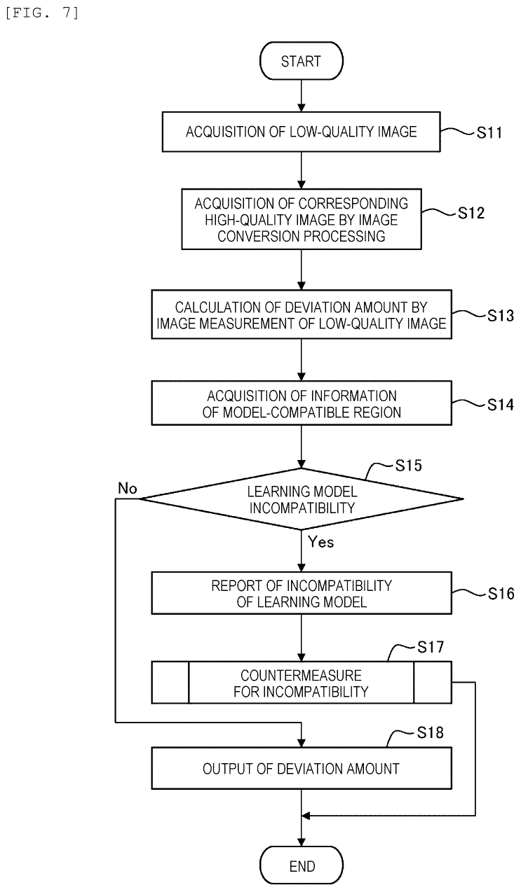

FIG. 7 is a flowchart showing a flow of processing of the incompatibility detection unit 10.

The image conversion unit 12 acquires the low-quality image 11 to be processed from the captured image storage unit 33 (image multidimensional collected data DB) (S11). The image conversion unit 12 may directly acquire the low-quality image 11 from the imaging device 30.

The image conversion unit 12 acquires (image conversion) the corresponding high-quality image 13 from the acquired low-quality image 11 using the learning model 14 (S12).

The image measurement processing unit 42 calculates a deviation amount of upper and lower layers by performing image measurement processing described in FIG. 4 using the acquired low-quality image 11 (S13).

The incompatibility detection unit 15 acquires the information of the model-compatible region registered in the DB of the learning model 14 (S14).

The incompatibility detection unit 15 determines whether the deviation amount of the low-quality image 11 calculated in S13 is within a section of the model-compatible region of the learning model 14 (S15), and the learning model 14 outside the section of the model-compatible region is regarded as learning model incompatibility.

If “Yes” in S15, the incompatibility detection unit 15 reports incompatibility of the learning model 14 in S15 via the incompatibility reporting unit 16 (S16). Further, the incompatibility countermeasure unit 20 may execute a countermeasure for the incompatibility (S17). On the other hand, if No in S15, the deviation amount is output (S18).

Hereinafter, an example of determination processing for the learning model incompatibility (S15) is described.

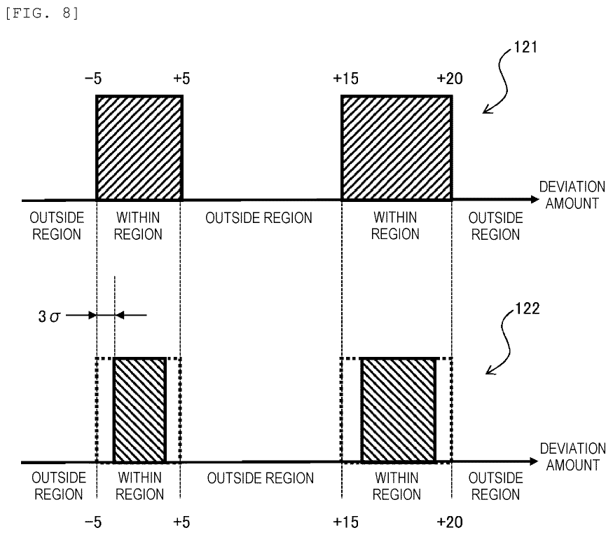

FIG. 8 is a diagram showing a section definition method of the model-compatible region. Two types of the definition method are shown below.

A section definition method 121 defines, as the model-compatible region, the section of the deviation amount of the training pair image used at the time of training. In the example of FIG. 8, the model-compatible region is a union of a first section ([−5, 5]) having a deviation amount of −5 to +5 and a second section ([15, 20]) having a deviation amount of +15 to +20. In FIG. 8, the section is expressed by a hatched bar graph.

The section definition method 122 defines a model-compatible region in consideration of an error between the deviation amounts described in FIG. 3.

In order to improve the reliability of the model-compatible region, it is desirable to reduce both ends of a section toward the inside of the section for each section (in the first section and the second section) in consideration of the error. A standard deviation 30 and the like of the error may be used as a reduced amount. 30 is a reliable section of 99.7%. That is, a probability that a value near a boundary in the model-compatible region of the section definition method 121 is outside a model-compatible region in a section definition method 122 is % (=100-99.7). Accordingly, the model-compatible region whose reliability is increased may be defined.

FIG. 9 is a diagram showing an example of a setting method of the model-compatible region.

The setting method of the section of the model-compatible region will be described. A horizontal axis of each of graphs 131 and 132 represents a deviation amount.

In the graph 131, a value of the deviation amount of the high-quality correct image 13B in a certain training pair image is indicated by a black dot, and an affection curve of the deviation amount is indicated by a mountain curve. A function, a width of a foot, and the like used to calculate the affection curve are obtained by an experiment and the like. The training pair images also have different distribution densities for a plurality of deviation amounts.

A vertical axis of the graph 131 describes a threshold for determining an affection of a deviation amount of a training pair image. If the affection curve is equal to or more than the threshold, it is determined as a model-compatible region. In FIG. 9, the first section ([−35, −25]), the second section ([−20, +5]), and a third section ([+10, +25]) are determined as sections in the model-compatible region.

The graph 132 indicates a part determined as a model-compatible region. In consideration of reliability and the like, reduction processing may be performed on the model-compatible region by using a method described in the section definition method 122 of FIG. 8 based on the model-compatible region of the graph 132.

An example of an expression method (region expression method) using a data format of the model-compatible region will be described.

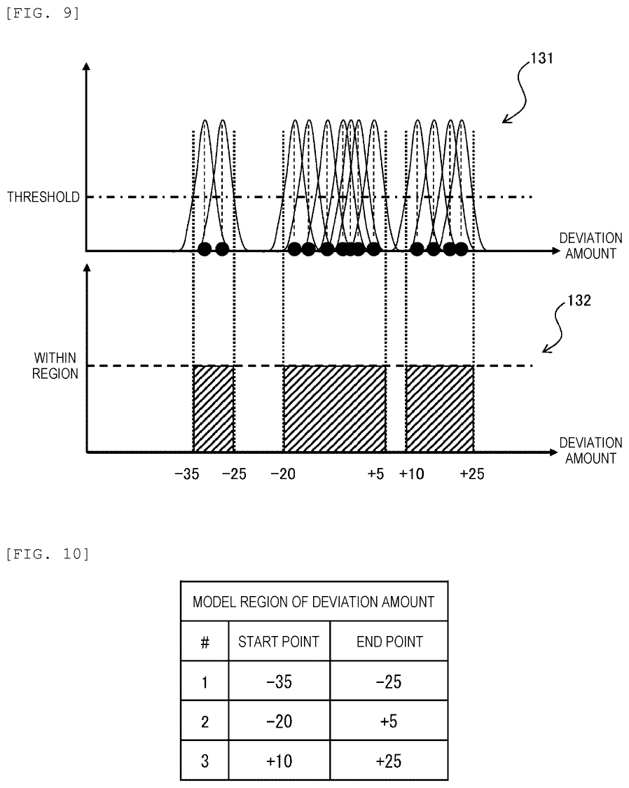

FIG. 10 is a table showing a first example of the region expression method.

In this table, values of the model-compatible region obtained in FIG. 9 are expressed by a start point and an end point of the deviation amount. In this case, learning model incompatibility determination processing of the incompatibility detection unit 15 may execute the determination processing (S15) so as to determinate whether the deviation amount of the low-quality image 11 is within the model-compatible region for each item number (#).

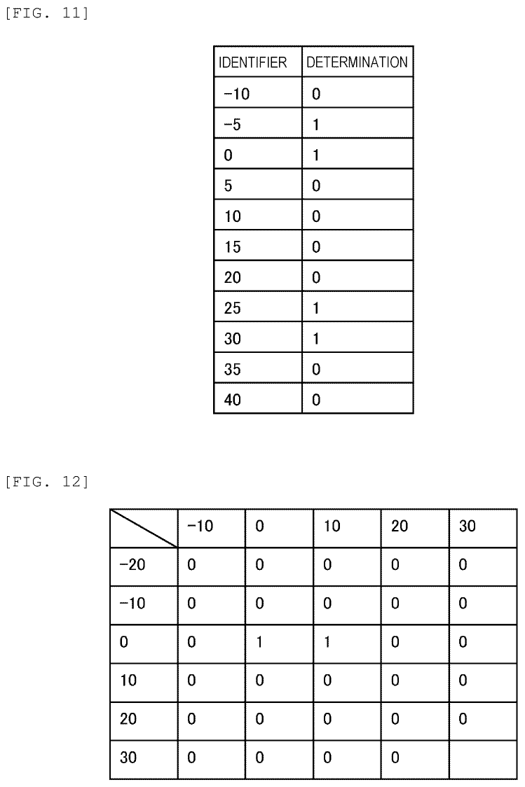

FIG. 11 is a table showing a second example of the region expression method.

In this table, a flag (right column) of whether it is a model-compatible region (=1) or not (=0) is set for each identifier of the model-compatible region (left column of the table).

The identifier of the model-compatible region is one value, but is treated as an identifier for identifying each model-compatible region having a width. For example, the identifier “−10” described in the table represents a model-compatible region [−10, −5). A symbol “[” includes a boundary, and a symbol “)” does not include a boundary. In this example, quantization of the model-compatible region is 5, and a deviation amount at the start point is the identifier thereof. In addition, the model training unit 10B can change a resolution of the model-compatible region by changing a quantization number.

When the table in FIG. 11 is used, the learning model incompatibility determination processing (S15) of the incompatibility detection unit 15 may determine a model-compatible region (the left column of the table) to which the deviation amount of the low-quality image 11 belongs, and may refer to the flag on the right column of the table to which the deviation amount belongs. If the flag is 1, the deviation amount is in the model-compatible region, and if the flag is 0, the deviation amount is not in the model-compatible region.

For example, when the deviation amount of the low-quality image 11 is a value of 16, since the deviation amount is included in the model-compatible region [15, 20), the incompatibility detection unit 15 sets the region identifier as “15”. Then, the incompatibility detection unit 15 determines that the model is incompatible by referring to the region identifier “15”→the flag “O” from the table in FIG. 11.

The expression method of FIG. 11 can be easily performed in multiple dimensions. Up to now, only a deviation amount in a horizontal direction is a target for the model-compatible region. Actually, a deviation amount in a vertical direction also occurs, and, for example, a change in image quality due to a difference in the acceleration voltage of the electron microscope 31, which is completely different from the deviation amount, occurs. It is necessary to perform training using a training pair image for each element.

FIG. 12 is a table showing a third example of the region expression method in which the table of FIG. 11 is expanded to a two-dimensional element. In the table of FIG. 11, a range of the identifier is from −10 to 40. In a table of FIG. 12, a range of the identifier is −20 to 30.

In the table of FIG. 12, an item in the horizontal direction indicates an identifier of the model-compatible region representing the deviation amount in the horizontal direction, and an item in the vertical direction indicates an identifier of the model-compatible region representing the deviation amount in the vertical direction. A numerical value in a cell in which the item in the horizontal direction and the item in the vertical direction intersect each other is represented by 1 when in the model-compatible region, and is represented by 0 when not in the model-compatible region. In this example, it is indicated that the deviation amount in the horizontal direction of [0, 20) is the model-compatible region, and the deviation amount in the vertical direction of [0, 10) is the model-compatible region.

When the table of FIG. 12 is used, the learning model incompatibility determination processing (S15) of the incompatibility detection unit 15 may determine a cell in the table to which a deviation amount of an element of the low-quality image 11 belongs, and may refer to a numerical value in the cell to which the deviation amount belongs.

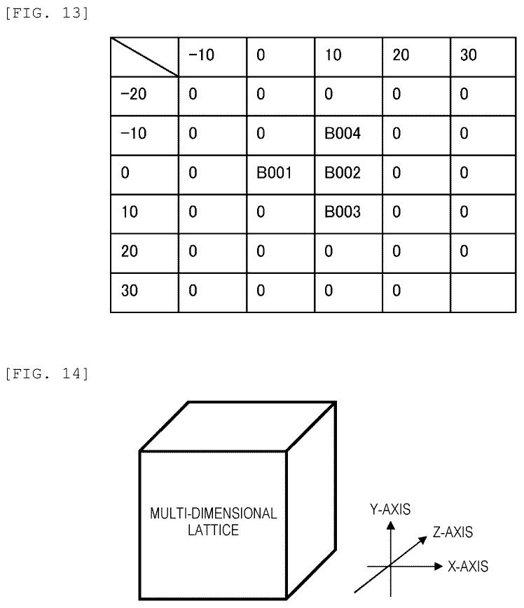

FIG. 13 is a table showing a modification in which a directory name storing a training pair image is stored in a cell value of the table of FIG. 12. A character string in the cell is represented by 0 when not in the model-compatible region, and is represented by other than 0 when in the model-compatible region.

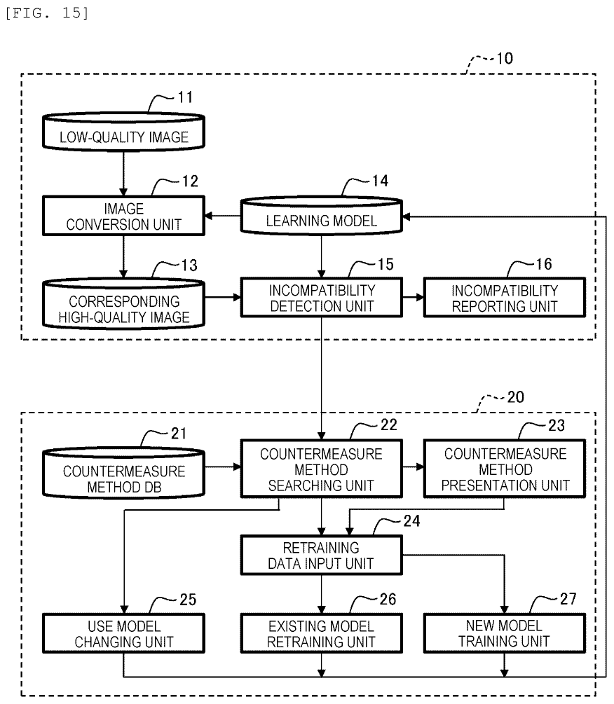

FIG. 14 is a data structure showing a fourth example of the region expression method in which the table of FIG. 11 is expanded to a three-dimensional element.

In FIG. 14, an X-axis represents the deviation amount in the horizontal direction, a Y-axis represents the deviation amount in the vertical direction, and a Z-axis represents the acceleration voltage. Although the expression of three dimensions or more cannot be shown, the region expression method can be expanded to n dimensions.

When the data structure of FIG. 14 is used, the learning model incompatibility determination processing (S15) of the incompatibility detection unit 15 may determine a cell in the table to which a combination of the deviation amount in the horizontal direction, the deviation amount in the vertical direction, and the acceleration voltage of the low-quality image 11 belongs, and may refer to a numerical value (not shown) in the cell to which the combination belongs.

According to Embodiment 1, it is possible to detect that the learning model is incompatible for an image to be processed, and to report that an error of the measurement result is large.

FIG. 15 is a configuration diagram of the incompatibility countermeasure unit 20.

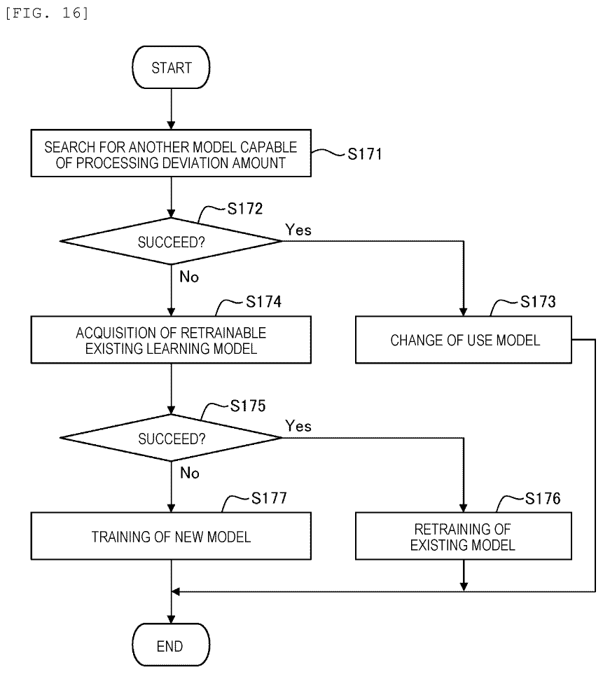

The incompatibility countermeasure unit 20 includes a countermeasure method searching unit 22, a countermeasure method presentation unit 23, a retraining data input unit 24, a use model changing unit 25, an existing model retraining unit 26, and a new model training unit 27. The incompatibility countermeasure unit 20 stores a countermeasure method DB 21. Hereinafter, details of the incompatibility countermeasure unit 20 will be described with reference to FIG. 16.

FIG. 16 is a flowchart showing specific processing of the incompatibility countermeasure processing (S17).

In this flowchart, countermeasure processing in which an operator is not interposed is described, and thereafter, a modification in which an operator is interposed will be described.

The use model changing unit 25 searches for another model capable of processing a deviation amount (S171). The use model changing unit 25 succeeds in the search in S171, and determines whether another model has been found (S172). If Yes in S172, the use model changing unit 25 changes a use model to another model found from a current incompatibility model (S173). The use model is the learning model 14 used by the image conversion unit 12 for conversion processing.

That is, when the incompatibility detection unit 15 detects incompatibility, the use model changing unit 25 searches a storage unit of the incompatibility countermeasure unit 20 for another learning model 14 corresponding to a model-compatible region that is compatible with the evaluation value of the input low-quality image 11, and controls the image conversion unit 12 to use another learning model 14 for the conversion processing of the input low-quality image 11.

Accordingly, the image conversion unit 12 can execute appropriate (small error) image conversion processing based on the learning model 14, which is changed in S173 and is compatible with the low-quality image 11 to be processed.

If No in S172, the countermeasure method searching unit 22 acquires a retrainable existing learning model from the DB of the learning model 14 (S174). The model acquired in S174 may be a current incompatibility model or another existing learning model. The countermeasure method searching unit 22 determines whether the acquisition of the existing learning model in S174 is successful (S175).

If Yes in S175, the existing model retraining unit 26 retrains an existing model (S176). That is, when the incompatibility detection unit 15 detects the incompatibility, the existing model retraining unit 26 retrains, based on the additional high-quality correct image 13B, the learning model 14 which is incompatible, thereby expanding the model-compatible region of the learning model 14.

If No in S175, the new model training unit 27 trains a new model (S177).

Therefore, the retraining data input unit 24 acquires a high-quality image of training material data used for retraining processing (S176) of the existing model retraining unit 26 and training processing (S177) of the new model training unit 27. The existing model is a model in which one or more times of training is performed, and the model-compatible region thereof also includes one or more sections. On the other hand, the new model is a model in an initial state in which training is not performed, and the model-compatible region thereof does not include a section.

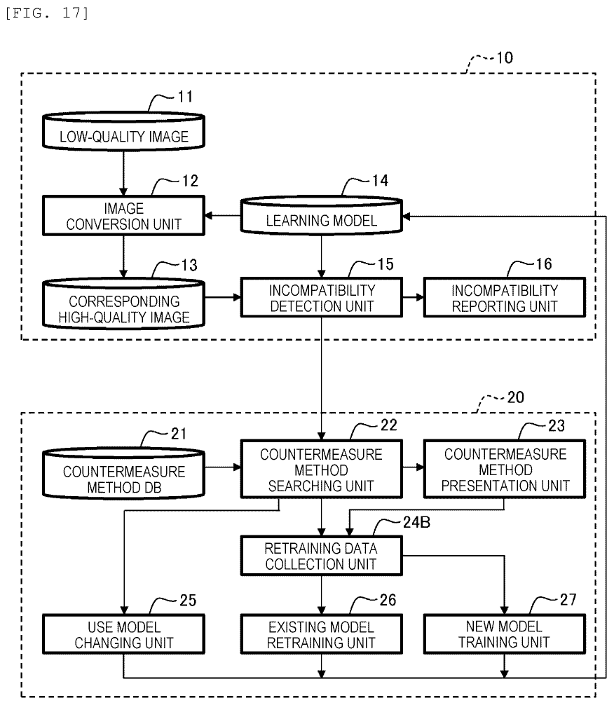

FIG. 17 is a configuration diagram showing a modification of the incompatibility countermeasure unit 20 of FIG. 15.

In FIG. 17, a retraining data collection unit 24b is provided instead of the retraining data input unit 24. The retraining data collection unit 24b executes automated driving according to a programmed operation procedure of the imaging device 30 to obtain a high-quality image without using the operation of the operator.

That is, the retraining data collection unit 24b operates the imaging device 30 according to the operation procedure set in advance, thereby receiving the input of the captured additional high-quality correct image 13B. In addition, the retraining data collection unit 24b may also execute automated driving in the same manner as the other processing in FIG. 16.

The countermeasure method presentation unit 23 may present, to the user, the following three types of countermeasure methods searched by the countermeasure method searching unit 22 from the countermeasure method DB 21 and operation procedures required for the countermeasure methods, and cause the user to select which countermeasure method is adopted. Therefore, in the countermeasure method DB 21, when it is determined by the incompatibility reporting unit 16 that a model is incompatible, information indicating what kind of operation is to be performed next is registered.

(Countermeasure Method 1) The use model changing unit 25 changes the use model (S173). The countermeasure method presentation unit 23 may display a candidate of the use model to be changed, and may determine the candidate of the use model that the operator has checked by pressing a check button and the like.

(Countermeasure Method 2) The existing model retraining unit 26 retrains the existing model (S176, details will be described in Embodiment 2). When retraining is performed, it is necessary to capture a high-quality image as training data. The high-quality image needs to be captured in an operation procedure different from that of normal imaging (imaging of the low-quality image 11). Therefore, the countermeasure method presentation unit 23 may display the operation procedure (recipe) on a screen in an easy-to-understand manner for a worker, and support the operation. Therefore, the countermeasure method DB 21 stores, for example, an imaging method of the additional high-quality correct image 13B for retraining, such as “in order to capture a high-quality image, please apply strong light to the object”. Contents stored in the countermeasure method DB 21 are various messages to be displayed on the screen of the worker.

(Countermeasure method 3) The new model training unit 27 trains a new model (S177). Similarly to (Countermeasure Method 2), the countermeasure method presentation unit 23 may display the operation procedure (recipe) on the screen in an easy-to-understand manner for the worker.

FIG. 18 is a hardware configuration diagram of the image conversion system.

Each processing unit (the incompatibility detection unit 10, the incompatibility reporting unit 16, the incompatibility countermeasure unit 20, the image usage unit 40, and the control display unit 50) of the image conversion system is implemented by a computer 900 including a CPU 901, a RAM 902, a ROM 903, an HDD 904, a communication I/F 905, an input and output I/F 906, and a medium I/F 907. The HDD 904 is implemented by, for example, a storage device that stores the learning model 14.

The communication I/F 905 is connected to an external communication device 915. The input and output I/F 906 is connected to an input and output device 916. The medium I/F 907 reads and writes data from and to a recording medium 917. Further, the CPU 901 controls each of the processing units by executing a program (also referred to as an application, or its abbreviation app) read into the RAM 902. Then, the program can also be distributed via a communication line, or be distributed by being stored in the recording medium 917 such as a CD-ROM.

The processing unit of the image conversion system may be any device as long as it is hardware capable of performing arithmetic processing on an image. For example, the processing unit may be any device, which is equipped with an arithmetic processing device such as a CPU or GPU of a computer and the like or a storage device such as an HDD and which performs arithmetic processing, or may use a field-programmable gate array (FPGA) that can program a logic operation circuit, or may manufacture dedicated hardware.

### Embodiment 2

In Embodiment 2, details of the retraining processing (S176) of the existing model performed by the existing model retraining unit 26 will be described. As an example of the retraining processing, adjustment processing of a learning model using generally used fine-tuning is performed, and a method of expanding a model-compatible region while causing the learning model to be compatible will be described. In the fine-tuning, the existing model is used in a state before training. A training pair image used for training is both a training pair image used at the time of generating the existing model (registered in the model-compatible region) and a training pair image of a region for expanding the model-compatible region (before registration in the model-compatible region).

By using both the training pair images, a learning model, which is compatible with both a model-compatible region covered by the learning model in an initial state and a model-compatible region to be added, is generated. Since the training pair images are also necessary for an expanded region, the high-quality correct image 13B is required in addition to the low-quality image 11. Therefore, an imaging operation of the high-quality correct image 13B occurs. The fine-tuning is effective in generating a model at a very high speed and improving a throughput of processing, as compared with a case where a learning model that has not been trained is trained as the initial state.

The fine-tuning is also suitable for generating a learning model in which a plurality of objects are combined, such as using a learning model that has been trained for removing noise as the initial state and training using a training pair image for improving aberration. That is, a retrained learning model can execute, for example, image conversion processing of improving both noise removal and aberration.

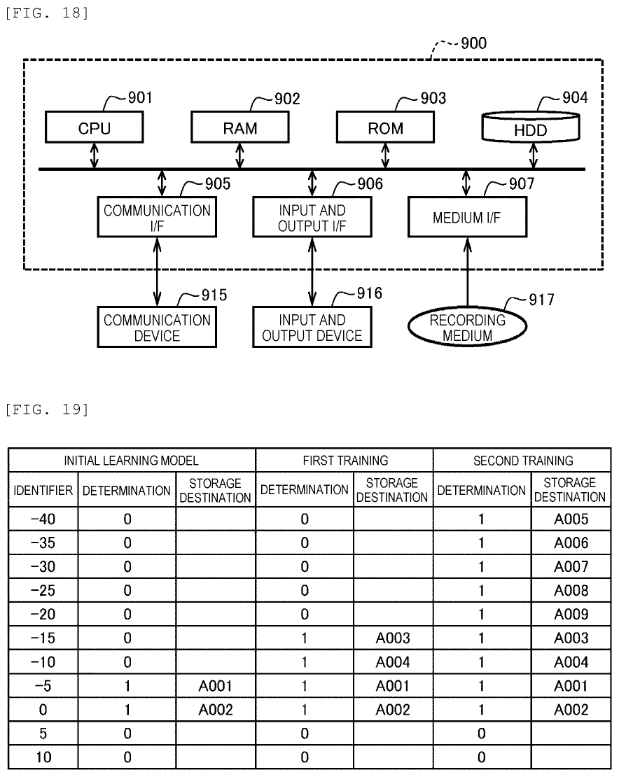

FIG. 19 is a diagram showing a state in which a numerical value in a table is changed by retraining for the table of the model-compatible region which is the same expression method as in FIG. 11.

The table of FIG. 19 is a table in which an initial learning model (first column to third column) in an initial state, a model (fourth and fifth columns) indicating a result of first retraining, and a model (sixth and seventh columns) indicating a result of second retraining are collected in one table. Since the three models have the same identifier of the model-compatible region, only the first column is described.

The second, fourth, and sixth columns of “determination” are flags of whether it is a model-compatible region (=1) or not (=0).

The third, fifth, and seventh columns of “storage destination” indicate directory names in which the training pair images used when the fine-tuning is performed and the learning model is adjusted are stored. The training pair image in the directory is used as training data during retraining.

The initial learning model indicates the model-compatible region (−5, 5), the first training result is expanded to the model-compatible region [−15, 5), and the second training result is expanded to the model-compatible region (−40, 5). The training pair images used for the first training are stored in the directory names “A003 and A004”, respectively. The training pair images used for the second training are stored in the directory names “A005 to A009”, respectively.

For example, when a magnitude of a deviation amount of the low-quality image 11 newly to be processed is a region [−15, −5), a part of the section [−15, −5) is outside the section and the initial learning model is incompatible, but when the first training result is used, the model is compatible in all sections.

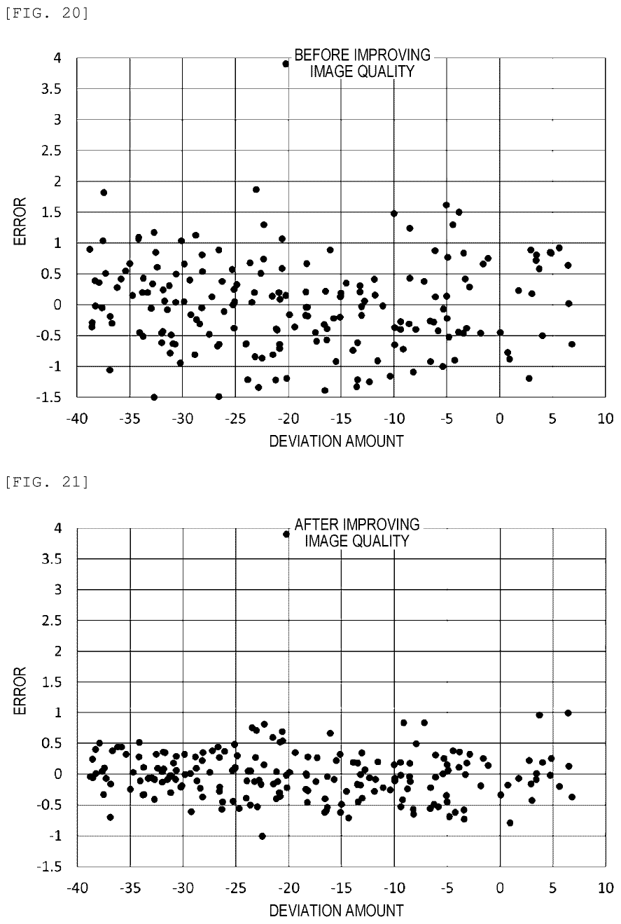

FIG. 20 is a graph showing a situation of occurrence of an error in the low-quality image 11 before processing (before improving image quality) performed by the image conversion unit 12.

FIG. 21 is a graph showing a situation of occurrence of an error in the corresponding high-quality image 13 after processing (after improving image quality) performed by the image conversion unit 12.

The horizontal axis of the graph indicates a deviation amount obtained using the corresponding high-quality image 13. The vertical axis of the graph indicates an error between a deviation amount obtained using the low-quality image 11 and the corresponding high-quality image 13 and a deviation amount obtained using the high-quality correct image 13B. The learning model 14 is generated using a training pair image in which a deviation amount between the upper and lower layers is −40 to +5.

Images measured for generating the graphs of FIGS. 20 and 21 are 200 images. FIG. 21 shows that variation in error is smaller in all deviation amounts than in FIG. 20. It is understood that the small variation in the error means that the accuracy is improved, and the measurement accuracy is further improved by the image conversion unit 12. The reason why the horizontal axis is not the deviation amount obtained from the high-quality image but the deviation amount obtained by using the corresponding high-quality image 13 is that the high-quality image cannot be used for the reason described in the problem of high-quality image acquisition in determination processing of learning model incompatibility.

In FIG. 21, a learning model is generated using the training pair image in which the deviation amount between the upper and lower layers is −40 to +5. The deviation between the upper and lower layers occurs due to some problem in a manufacturing process. In an actual operation, it is difficult to prepare images having such a wide range of deviation amounts as training pair images.

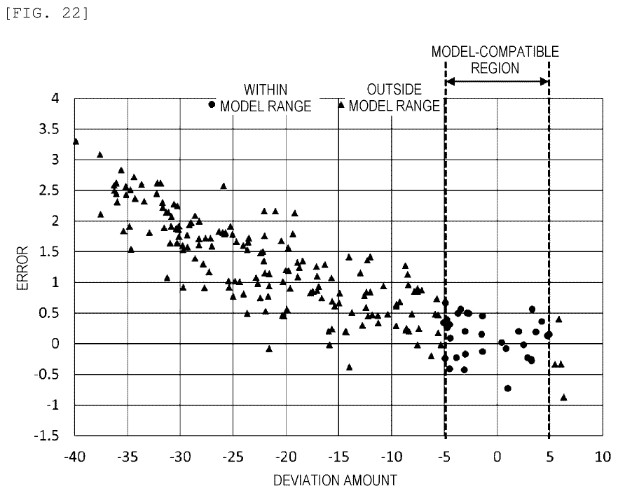

FIG. 22 is a diagram showing a state of a measurement error when an image is converted using a learning model in which the deviation amount of the training pair image is defined as a model-compatible region [−5, 5).

In the section of the model-compatible region in FIG. 22, the variation in the error is substantially the same value as in FIG. 21, and the improvement of the measurement accuracy is recognized. However, in a case of an image that is deviated to a negative side from the model-compatible region, the error increases as a distance from the model-compatible region increases. Accordingly, when the deviation amount of the low-quality image 11 is within the model-compatible region, the variation in the error is small, and an inappropriate movement of a circuit pattern is also small. When the deviation amount of the low-quality image 11 is not within the model-compatible region, the variation in the error is large, and the inappropriate movement of the circuit pattern is also large.

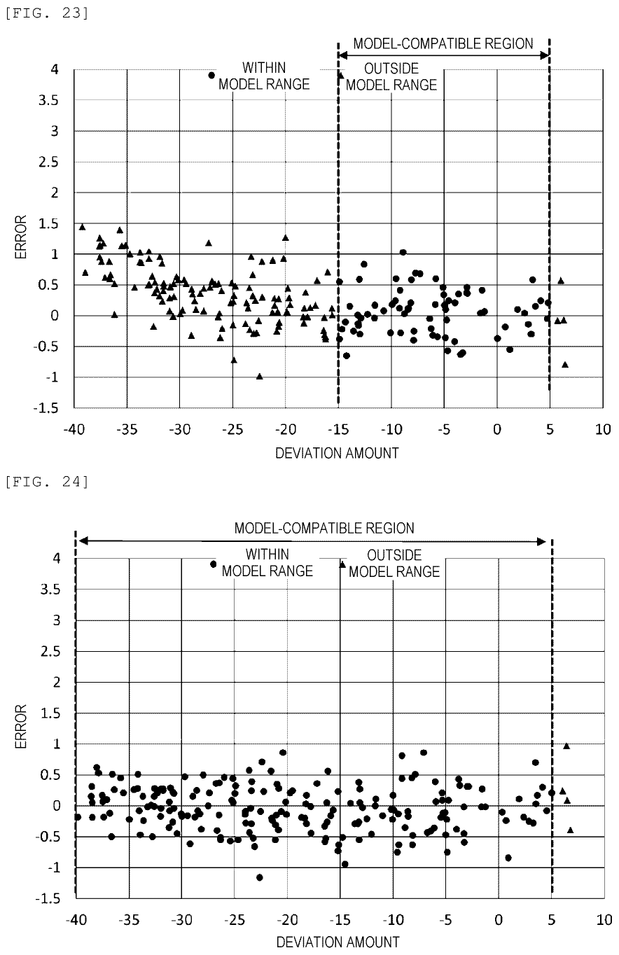

FIG. 23 is a graph showing a situation of occurrence of an error based on a first training result.

It is understood that the model-compatible region is expanded to the section of [−15, 5), and the error (vertical axis) in the section is small by the fine-tuning. Based on the model-compatible region [−15, 5) of the learning model 14, the incompatibility detection unit 15 determines the following model compatibility.

FIG. 24 is a graph showing a situation of occurrence of an error based on a second training result.

It is understood that the model-compatible region is expanded to the section of [−40, 5), and the error (vertical axis) in the entire section is small by the fine-tuning. Based on the model-compatible region [−40, 5) of the learning model 14, the incompatibility detection unit 15 determines the following model compatibility.

As shown in FIG. 9, the deviation amount of the training pair image to be obtained is concentrated at one place and is rough. When a large number of images are concentrated in a region of an identifier of a certain model-compatible region, a weight of the region becomes large and imbalanced retraining may occur.

Therefore, it is desirable that a quantization width of a model-compatible region of a table expressing the model-compatible region of FIG. 11 or the like is constant. Accordingly, the occurrence of such imbalance can be prevented by making the number of the training pair images in each model-compatible region constant.

In the incompatibility detection unit 10 according to the embodiment described above, the incompatibility detection unit 15 determines whether the learning model 14 used to convert the low-quality image 11 into the corresponding high-quality image 13 is compatible with the low-quality image 11. Since the learning model 14 is incompatible with the low-quality image 11 of the input data based on the determination of the incompatibility detection unit 15, the incompatibility reporting unit 16 notifies that the corresponding high-quality image 13 is not the target high-quality image.

Accordingly, even when an improvement has been made in the corresponding high-quality image 13, the user can grasp the model incompatibility, so that erroneous determination of an image content based on the corresponding high-quality image 13 can be prevented.

In addition, the incompatibility countermeasure unit 20 adds, to the training data, a training target image corresponding to the low-quality image 11 of the input data for which the learning model 14 is determined to be incompatible, and performs a countermeasure such as retraining. Accordingly, the learning model 14 compatible with the low-quality image 11 is generated.

Accordingly, by retraining the learning model 14, it is possible to sequentially expand the model-compatible region corresponding to the learning model 14. For example, although the learning model is compatible for noise, when the learning model is not compatible for aberration, the existing model retraining unit 26 can generate, by retraining using both a noise image and an aberration image, the learning model 14 compatible with both the noise image and the aberration image.

The invention is not limited to the embodiments described above and includes various modifications. For example, the embodiments described above have been described in detail to facilitate understanding of the invention, and the invention is not necessarily limited to those including all the configurations described above.

A part of a configuration of a certain embodiment can be replaced with a configuration of another embodiment, and the configuration of another embodiment can be added to the configuration of a certain embodiment.

A part of a configuration of each embodiment may be added to, deleted from, or replaced with another configuration. A part or all of configurations, functions, processing units, processing methods, and the like described above may be implemented by hardware by, for example, designing with an integrated circuit.

In addition, the configurations, functions, and the like described above may be implemented by software by a processor interpreting and executing a program for implementing each function.

Information such as a program, a table, and a file for implementing each function can be stored in a recording device such as a memory, a hard disk, and a solid state drive (SSD) or a recording medium such as an integrated circuit (IC) card, an SD card, and a digital versatile disc (DVD). In addition, a cloud can also be used.

Control lines and information lines indicate what is considered to be necessary for description, and not necessarily all control lines and information lines are always shown on a product. Actually, almost all configurations may be considered to be connected.

Further, a communication unit for connecting devices is not limited to a wireless LAN, and may be changed to a wired LAN or another communication unit.

### REFERENCE SIGNS LIST

10: incompatibility detection unit (incompatibility detection device)
10B: model training unit
11: low-quality image (image-before-conversion)
12: image conversion unit
12B: weight correction unit
13: corresponding high-quality image (image-after-conversion)
13B: high-quality correct image (training image)
14: learning model
15: incompatibility detection unit
16: incompatibility reporting unit
20: incompatibility countermeasure unit (incompatibility detection device)
21: countermeasure method DB
22: countermeasure method searching unit
23: countermeasure method presentation unit
24: retraining data input unit
24b: retraining data collection unit
25: use model changing unit
26: existing model retraining unit
27: new model training unit
30: imaging device
31: electron microscope
32: X-ray tomographic device
33: captured image storage unit
40: image usage unit
41: image observation processing unit
42: image measurement processing unit
43: image classification processing unit
50: control display unit

1. An incompatibility detection device comprising:
a learning model configured to perform an image conversion and to be inputted with or to output an image;
an incompatibility detection unit configured to detect whether the learning model is incompatible;
an incompatibility reporting unit configured to report detected incompatibility; and
a storage unit configured to store, as a model-compatible region, a distribution of evaluation values of training images used in a training stage of the learning model, in association with the learning model, wherein
the incompatibility detection unit determines that the learning model is incompatible when an evaluation value of the image is not within the model-compatible region.

2. The incompatibility detection device according to claim 1, further comprising:
a use model changing unit, wherein
when the incompatibility detection unit detects incompatibility, the use model changing unit searches the storage unit for another learning model corresponding to the model-compatible region that is compatible with the evaluation value of the image, and uses the other learning model for conversion processing of the image.

3. The incompatibility detection device according to claim 1, further comprising:
an existing model retraining unit, wherein
when the incompatibility detection unit detects incompatibility, the existing model retraining unit expands the model-compatible region of the learning model by retraining, based on an additional training image, the learning model which is incompatible.

4. The incompatibility detection device according to claim 3, further comprising:
a countermeasure method presentation unit; and
a retraining data input unit, wherein
the countermeasure method presentation unit presents an incompatibility countermeasure method including an imaging method of the additional training image, and
the retraining data input unit receives an input of the additional training image captured by the presented imaging method.

5. The incompatibility detection device according to claim 3, further comprising:
a retraining data collection unit, wherein
the retraining data collection unit receives an input of the additional training image captured by operating an imaging device according to an operation procedure set in advance.

6. An incompatibility detection method, wherein
an incompatibility detection device includes
a learning model configured to perform an image conversion and to be inputted with or to output an image,
an incompatibility detection unit configured to detect whether the learning model is incompatible,
an incompatibility reporting unit configured to report detected incompatibility, and
a storage unit configured to store, as a model-compatible region, a distribution of evaluation values of training images used in a training stage of the learning model, in association with the learning model, and
the incompatibility detection unit determines that the learning model is incompatible when an evaluation value of the image is not within the model-compatible region.

7. The incompatibility detection device according to claim 1, wherein
the image is an image of a circuit pattern formed on a semiconductor wafer, and
the evaluation value of the image is a deviation amount of the circuit pattern, aberration, or a noise removal amount obtained from the image.
